(19) United States
(12) Patent Application Publication
(10) Pub. No.: US 2021/0041377 A1
(43) Pub. Date: Feb. 11, 2021

(54) RADIOGRAPHIC PHASE IMAGING DEVICE

(71) Applicant: Tohoku University, Sendai-shi Miyagi (JP)

(72) Inventor: Atsushi Momose, Sendai-shi (JP)

(21) Appl. No.: 16/977,610

(22) PCT Filed: Feb. 18, 2019
(86) PCT No.: PCT/JP2019/005746

§ 371 Date: Sep. 2, 2020

(30) Foreign Application Priority Data
Mar. 6, 2018 (JP) 2018-039367

(51) Int. Cl. G01N 23/041; G01N 23/083; G01T 1/20

(52) U.S. Cl. CPC G01N 23/041; G01N 2223/401; G01T 1/2006; G01N 23/083

(57) ABSTRACT

A radiographic phase imaging device that provides for examination, even for a comparatively large structure, with high sensitivity, includes a first arm and a second arm that are arranged in a state having a space formed between them in which it is possible to arrange a subject. A radiation source section is attached to the first arm. The radiation source section includes a radiation source that generates radiation, and a G1 grating that allows the radiation to pass through. A detection section is attached to the second arm. The detection section acquires an image of radiation that has passed through the G1 grating and the subject. The first arm and the second arm are configured so that it is possible to move the radiation source section and the detection section within a three dimensional space.

### BACKGROUND

### Technical Field

The present disclosure relates to technology for observing the internal structure of a sample with high sensitivity, utilizing wave properties of radiation that has passed through a sample (subject), such as X-rays.

### Description of the Related Art

Radiation of high penetrating power, such as X-rays, is widely used as a probe for observing the inside of an object in medical image diagnosis, non-destructive testing, security checking, etc. With regard to contrast of a fluoroscopic image, an object that strongly absorbs X-rays is depicted as an X-ray shadow, due to differences in X-ray attenuation coefficient. X-ray absorption becomes stronger for objects that contain more elements with higher atomic number. Conversely, for a material that is made up of elements of low atomic number, it can also be pointed out that it is difficult to obtain contrast, and this is also a disadvantage of fluoroscopic images in principle. It is therefore not possible to obtain sufficient sensitivity for soft biological tissue, organic material etc.

On the other hand, a method of overcoming the above-mentioned problem by using phase contrast is known. As an approach for realizing a high sensitivity imaging method that uses phase contrast of radiation such as x-rays or a neutron beam, a method that uses a transmission grating has been proposed. An intensity pattern formed on an image detector by radiation that has passed through a transmission grating and an object that are appropriately arranged changes in accordance with slight refraction and scattering of radiation in the object. It is possible to obtain contrast that represents the structure of the object by means of this phenomenon. Absorption images corresponding to conventional images, refraction images that show magnitude of X-ray refraction by the object, and scattering images that show magnitude of scattering by the object, are generally produced by this method.

In a case where the grating period of a transmission grating that is used is minute, a detector is arranged at a position where the contrast of the intensity pattern is strongly visible, taking into consideration a fractional Talbot effect due to the interference effect (so-called diffraction effect) caused by the grating. Also, in a case where the intensity pattern becomes too fine to resolve directly with an image detector, it is possible to visualize changes of the intensity pattern by arranging another transmission grating at that position to generate a moiré pattern. It should be noted that hereafter an initial transmission grating will be referred to as G1, and a second transmission grating will be referred to as G2. A structure composed of G1 and G2 will be referred to as a Talbot interferometer.

In operating a Talbot interferometer, a spatial coherence length of the radiation irradiated to G1 is preferably equal to or greater than the G1 period. This means that there is a need for waves of the radiation to be well-ordered (in other words, spatially coherent), and when X-rays, for example, are used, this demand is satisfied by using synchrotron radiation or a microfocus X-ray source. In particular, the use of a microfocus X-ray source is worth noting when considering practical use because it is available in a laboratory.

However, since the output power of a microfocus X-ray source is limited, an exposure time of from several minutes to a few tens of minutes is normally required. An X-ray source that is generally used is of higher power than a microfocus X-ray source, but spatial coherence necessary for operating an X-ray Talbot interferometer is not expected.

A Talbot-Lau interferometer is known that has a third grating (hereafter referred to as G0) arranged close to a generic X-ray source. As a result, since it is possible to shorten exposure time, it is possible to significantly increase the speed of photographing. In a case where a neutron beam is used as the radiation, since it cannot be expected to have spatial coherence with current neutron sources, G0 is always used.

It is necessary for G0 and G2 to be amplitude type gratings. Specifically, grating members that block radiation are required to be sufficiently thick, and high aspect ratio structure formation is accordingly required for G0 and G2. In particular, for G2, since the surface area of G2 governs imaging field of view, a high aspect ratio structure should be formed in an area as large as possible. In addition, higher energy X-rays are required in imaging a thicker object, and for this reason a higher aspect ratio of a grating is required. Fabrication of these kind of gratings is not easy, and this is a technical obstacle in the development of this method.

Also, when radiation that it is supplied radially from a radiation source is used (so-called cone beam radiation), if a high aspect ratio grating is formed into a flat plate, at the edges of the grating, paths of the radiation and the grating member become not parallel, and a problem arises in that radiation cannot pass through the grating. In order to avoid this, it is also necessary for the grating to have a curved shape such that the radiation source is at the center of curvature.

In order to overcome such difficulties, a Lau interferometer is known in which G0 and G1 are both arranged close to a radiation source, and G2 is omitted (refer to patent publication 1 below). According to this configuration, since G0 and G1 are arranged close to the vertex of a radiation cone beam, surface areas of these gratings do not need to be large. It should be noted that G1 may be a phase grating, and the thickness of the pattern of this phase grating can be made significantly thicker than the pattern thickness of an amplitude grating.

With either configuration, it is scarce to use directly an intensity pattern or a moiré image recorded by an image detector, and absorption images, refraction images, and scattering image, etc., are generated and used by processing the recorded images using a specific procedure with a computer. With many methods, a fringe scanning method is adopted for this purpose, with the assumption that an object is stationary within the field of view. The fringe scanning method is the method with which one of the gratings is translated in its periodic direction, a plurality of intensity patterns or moiré images are recorded, and the image operation is performed. As a specific example, photographs are taken by translating one of the gratings by 1/M of its period d, and this is repeated M times to obtain M images, which are then used for image operations. M is an integer of 3 or greater. Hereafter this type of image generating method that uses phase contrast will be referred to as phase imaging.

Also, as a method that enables the above-mentioned imaging for an object that moves on a belt conveyor, the method of patent publication 2 below has been proposed. According to this method, phase imaging that does not require grating translation becomes possible. Specifically, this technique is a method that uses moiré images generated as a result of deformation and inclination of the gratings, creates a situation where moiré fringes are generated in the field of view, and samples necessary data for a fringe scanning method by having the object passed there through.

A Lau interferometer having a configuration with an amplitude grating G2 omitted has been mentioned above, and there is a method described in prior publications (refer to patent publications 3 to 5 below) which uses a structured X-ray source for omitting another amplitude grating G0. Generally, X-rays are generated by irradiating an excitation beam such as an electron beam to a metallic target. With the method that uses the structured X-ray source, it is possible to patternize an X-ray generating area itself by forming a desired pattern on the metallic target, and it is possible to cause the function of G0 to be exhibited in this pattern.

### CITATION LIST

### Patent Literature

[Patent publication 1] Japanese patent No. 5601909

[Patent publication 2] Japanese patent Laid-open No. 2017-044603

[Patent publication 3] Japanese patent No. 5158699

[Patent publication 4] Japanese patent Laid-open No. 2015-47306

[Patent publication 5] U.S. Pat. No. 9,719,947

### Non-Patent Literature

[Non-patent publication 1] A. Momose et al., Opt. Express 17 (2009) 12540.

### BRIEF SUMMARY

### Technical Problem

In a case where a subject (object) is large, it is necessary for a grating (in particular, a G2 grating) to be large, and there is a problem in that device costs and maintenance costs increase. Also, with an equipment that moves a subject, although it is possible to photograph desired sites of the subject, installing a movement mechanism for moving a large subject incurs a problem of increased device cost and increased maintenance cost.

The present disclosure has been conceived based on the above described circumstances. An aspect of the present disclosure is to provide technology that is capable of examining a comparatively large structure with high sensitivity.

### Solution to Problem

The present disclosure can be understood as described in the following aspects.

(Aspect 1)

A radiographic phase imaging device, comprising a drive section, a radiation source section, and a detection section, wherein the drive section comprises a first arm and a second arm. The first arm and the second arm are arranged in a state having a space formed between them in which it is possible to arrange a subject. The radiation source section is attached to the first arm. The radiation source section comprises a radiation source that generates radiation, and a G1 grating that allows the radiation to pass through. The detection section is attached to the second arm. The detection section is configured to acquire images of the radiation that has passed through the G1 grating and the subject. The first arm and the second arm are configured such that the radiation source section and the detection section can be moved within a three dimensional space.

(Aspect 2)

The radiographic phase imaging device described in aspect 1, wherein a structured radiation source having target members arranged periodically is used as the radiation source.

(Aspect 3)

The radiographic phase imaging device described in aspect 2, wherein the structured radiation source and the G1 grating are integrated within the radiation source section.

(Aspect 4)

The radiographic phase imaging device described in any one of aspect 1 to aspect 3, wherein the detection section comprises an image detector and a G2 grating, and the image detector is configured to acquire an image of the radiation that has passed through the G1 grating, the subject, and the G2 grating,

(Aspect 5)

The radiographic phase imaging device described in aspect 4, wherein the image detector and the G2 grating are integrated within the detection section.

(Aspect 6)

The radiographic phase imaging device described in any one of aspect 1 to aspect 3, wherein the detection section comprises an image detector and a structured scintillator, and wherein the image detector is configured to acquire an image of the radiation that has passed through the G1 grating and the subject, and has been made incident on the structured scintillator.

(Aspect 7)

The radiographic phase imaging device described in any one of aspect 1 to aspect 6, wherein the first arm and the second arm are configured to be able to allow movement of one or both of the radiation source section and the detection section along a specified movement trajectory within a three dimensional space, while maintaining a relative positional relationship between the radiation source section and the detection section.

(Aspect 8)

The radiographic phase imaging device described in aspect 7, wherein the radiation source section and the detection section are configured to be able to execute imaging while moving one or both of the radiation source section and the detection section along the movement trajectory.

(Aspect 9)

The radiographic phase imaging device described in any one of aspect 1 to aspect 8, wherein the first arm and the second arm are respectively constituted using robot arms.

(Aspect 10)

The radiographic phase imaging device described in any one of aspect 1 to aspect 8, wherein the first arm and the second arm are integrated, and are formed into a substantially C-shape overall.

### Advantageous Effect of the Disclosure

According to the present disclosure, it is possible to perform high sensitivity image inspection even for a comparatively large structure, and even if the structure is kept stable, without the need for a large grating.

### BRIEF DESCRIPTION OF THE SEVERAL VIEWS OF THE DRAWINGS

FIG. 1 is an explanatory drawing showing the schematic structure of a radiographic phase imaging device of a first embodiment of the present disclosure.

FIG. 2 is an explanatory drawing showing the schematic structure of a radiation source section used in the device of FIG. 1.

FIG. 3 is a perspective drawing schematically showing a structured target and a grating, used in the radiation source section of FIG. 2.

FIG. 4 is an explanatory drawing schematically showing a positional relationship of each member of the device of FIG. 1.

FIG. 5 is an explanatory drawing showing one example of a movement pattern for a drive section and radiation source section in the device of FIG. 1.

FIG. 6 is an explanatory drawing showing one example of a movement pattern for a drive section and radiation source section in the device of FIG. 1.

FIG. 7 is an explanatory drawing showing one example of a movement pattern for a drive section and radiation source section in the device of FIG. 1.

FIG. 8 is an explanatory drawing showing one example of a movement pattern for a drive section and radiation source section in the device of FIG. 1.

FIG. 9 is an explanatory drawing schematically showing a positional relationship of each member used in a radiation imaging device of a second embodiment of the present disclosure.

FIG. 10 is an explanatory drawing schematically showing a positional relationship of each member used in a radiation imaging device of a third embodiment of the present disclosure.

### DETAILED DESCRIPTION

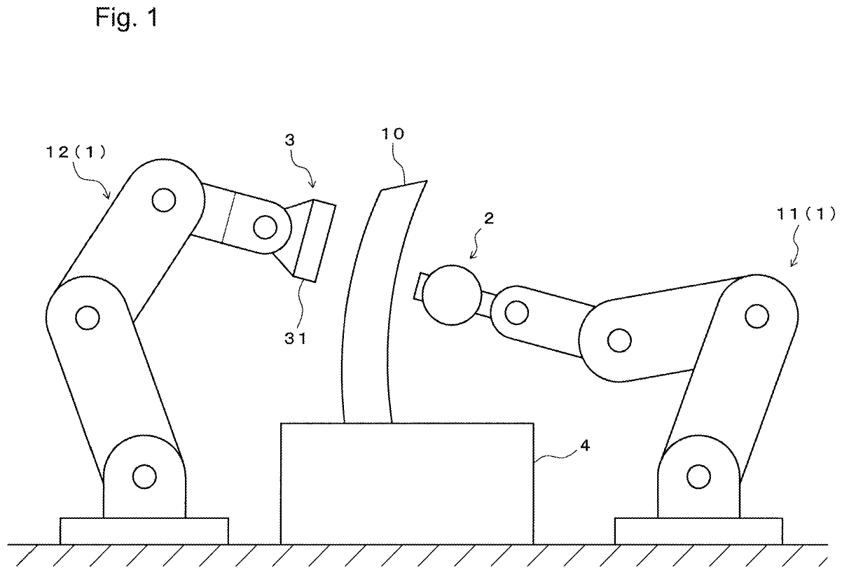

In the following, a radiographic phase imaging device (hereafter sometimes referred to as “imaging device” or simply “device”) of a first embodiment of the present disclosure will be described with reference to FIG. 1 to FIG. 8.

### Structure of the First Embodiment

The imaging device of this embodiment comprises a drive section 1, a radiation source section 2, and a detection section 3. This device further comprises a conveying section 4 as an additional element.

(Drive Section)

The drive section 1 is comprised of a first robot arm 11 and a second robot arm 12. The first robot arm 11 and the second robot arm 12 are arranged in a state where a space in which a subject 10 can be arranged is formed between them. Here, the first robot arm 11 and the second robot arm 12 correspond to a specific example of a first arm and second arm of the present disclosure.

Further, the first robot arm 11 and the second robot arm 12 are configured so that it is possible to move the radiation source section 2 and the detection section 3 within a three dimensional space.

More specifically, the first robot arm 11 and second robot arm 12 of this example are configured so that it is possible to move one or both of the radiation source section 2 and the detection section 3 along a specified movement trajectory within a three-dimensional space, with a relative positional relationship between the radiation source section 2 and the detection section 3 kept as it is.

(Radiation Source Section)

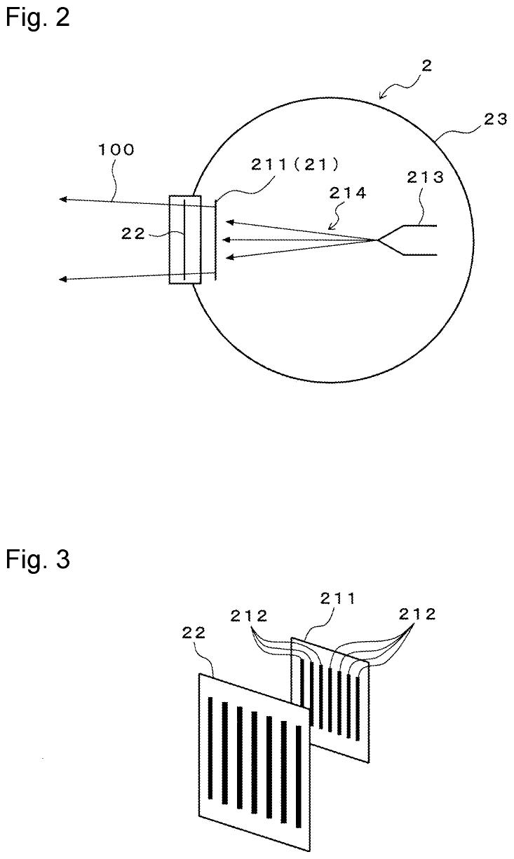

The radiation source section 2 is attached to the first robot arm 11. The radiation source section 2 comprises a radiation source 21 that generates radiation, a G1 grating 22 that allows radiation to pass through, and a vacuum chamber 23 that houses the radiation source 21 inside (refer to FIG. 2).

The radiation source 21 of this embodiment comprises a substrate 211 that is arranged inside the vacuum chamber 23, target members 212 (refer to FIG. 3) that are arranged periodically on this substrate 211, and an electron source 213. A diamond substrate, for example, has been used as the substrate 211, but this is not limiting. Tungsten, for example, has been used as the target members 212, but this is not limiting.

By having the periodically arranged target members 212, the radiation source 21 of this embodiment is made a so-called structured radiation source. That is, the configuration is such that the radiation source 21 itself has function of a normal G0 grating. It is therefore possible to omit the G0 grating.

The electron source 213 is configured to generate radiation (here, X-rays) 100 by irradiating an electron beam 214 towards the target members 212. However, it is also possible to excite X-rays using a laser instead of the electron source 213.

The G1 grating 22 is installed at a position where radiation 100 passes through, either inside the vacuum chamber 23 or at an outer side of the chamber. The G1 grating 22 is generally installed by way of a precision stage that can be appropriately controlled from outside, in order to adjust a relative positional relationship with the G0 grating (here, the target members 212 of the structured X-ray source), but with this practical example, the G1 grating 22 is directly integrated with the vacuum chamber 23, in the interests of reduced weight. Specifically, the G1 grating 22 can be directly formed on a window (beryllium window or diamond window, etc.) for extracting radiation (X-rays here) from the vacuum chamber 23. That is, by making the G1 grating 22 on the window as a substrate and fitting this window to the vacuum chamber 23, it is possible to integrate the G1 grating 22 and the target members 212 (structured X-ray source) by means of the vacuum chamber 23.

Normally a phase type grating is used as the G1 grating 22, but it is also possible to use an absorption type grating.

(Detection Section)

The detection section 3 is attached to the second robot arm 12. The detection section 3 of this embodiment is provided with an image detector 31. This image detector 31 is configured to obtain an image of radiation that has passed through the G1 grating 22 and the subject 10.

In more detail, the detection section 3 has a structure with pixels arranged next to each other two-dimensionally, both laterally and longitudinally, and detects radiation that has arrived through the G1 grating 22 by every pixel. The detection section 3 can also acquire moving images at a specified frame rate.

The radiation source section 2 and the detection section 3 are configured to be able to perform imaging in a similar manner to that described in patent publication 2, for example, while moving one or both of the radiation source section 2 and the detection section 3 along a movement trajectory. With patent publication 2, there is a step of measuring the shape of a moiré image that is generated by the device itself in a state where there is no subject, using a fringe scanning method together with grating translation. However, with this practical example, since a translation mechanism is not provided for the G1 grating 22, the same function is realized with another method. Specifically, the image detector 31 detects a self-image caused by the G1 grating 22. A self-image is a finely striped pattern, and by processing this self-image using a Fourier transform, measurement processing of the moiré image is performed. A Fourier transform mentioned here is described in previously mentioned non-patent publication 1, for example, and so further description is omitted.

(Conveying Section)

A conveying section 4 is configured to be able to convey the subject 10 to a specified position, and is constructed using, for example, a conveyor that is capable of controlling movement position and movement speed of the subject 10.

(Establishing Conditions of this Embodiment)

The previously described embodiment satisfies the following conditions (equations). However, in this specification, “satisfy conditions” does not have a mathematical precise meaning, as long as conditions are satisfied to the extent that there is no technical problem.

$$\begin{matrix}Equation 1 & \\ 1 - \frac{{d}_{1}}{{d}_{0}} = \frac{a}{a + b} & ( 1 ) \\ Equation 2 & \\ \frac{1}{a} + \frac{1}{b} = \frac{λ}{{pd}_{1}^{2}} & ( 2 ) \\ Equation 3 & \\ 2 D < \frac{{d}_{0} {d}_{1}}{{d}_{0} - {d}_{1}} & ( 3 )\end{matrix}$$

Here,

d₀: pitch of target members (pitch of structured radiation source)

d₁: pitch of G1 grating 22

a: distance between G1 grating and target members

b: distance between G1 grating and image detector

λ: wavelength of radiation (X-rays) where interferometer configuration becomes optimum

D: pixel size of image detector, in the direction of grating period

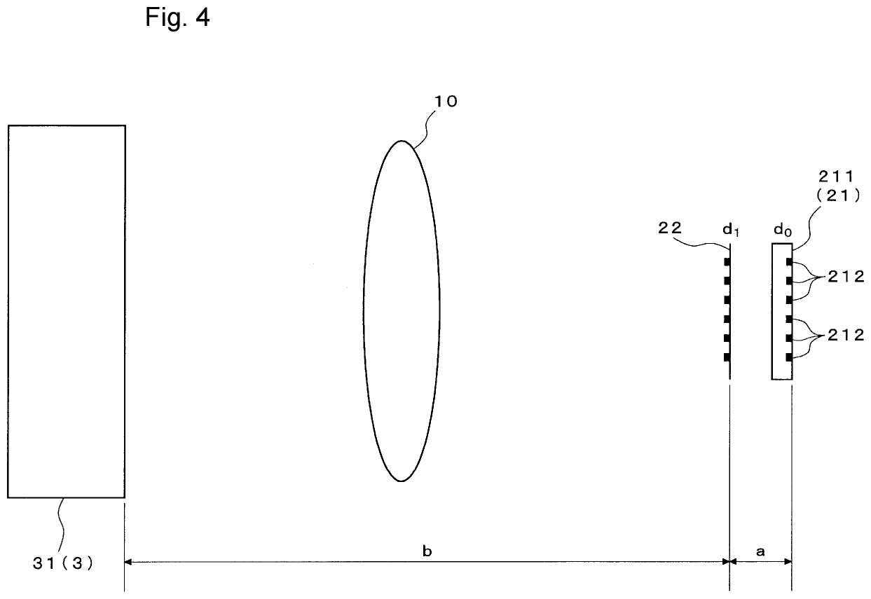

p: Talbot order
(refer to FIG. 4). Assuming that a π/2 phase grating is used as the G1 grating here, then p is a half integer in that case. In a case where the radiation that is used is continuous X-rays, then λ can be approximated from the center wavelength of the continuous X-rays.

When the above conditions are satisfied, a Lau interferometer configuration becomes possible, which means that the G2 grating can be omitted.

(Operation of this Embodiment)

With this embodiment, the subject 10 is arranged between the first robot arm 11 and the second robot arm 12 using the conveying section 4. Then, the electron beam 214 is irradiated from the electron source 213 of the radiation source section 2 to the target members 212 (refer to FIG. 3), and radiation 100 is irradiated to the G1 grating 22 (refer to FIG. 2). Radiation that has passed through the G1 grating 22 passes through the subject 10 and is detected by the image detector 31 of the detection section 3. In this way, with this embodiment, it is possible to acquire an intensity distribution image for the radiation.

Also, with this embodiment, the robot arms 11 and 12 are moved so that the radiation 100 is relatively scanned with respect to the subject 10. Performing scanning by moving the subject 10 is also possible.

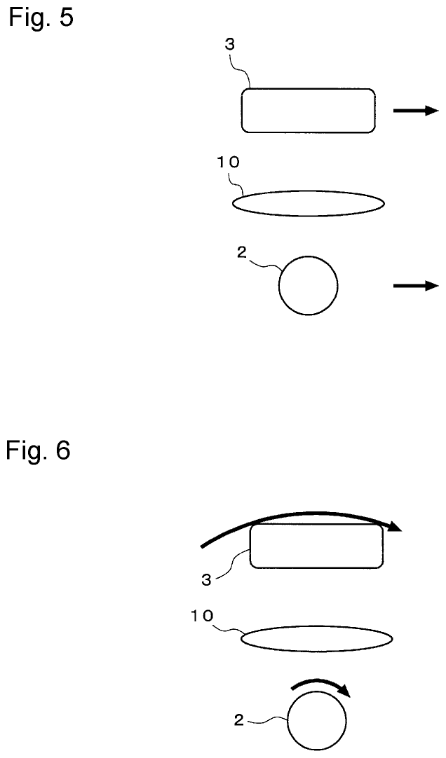

More specifically, with this embodiment, a positional relationship between the radiation source section 2, detection section 3, and subject 10 is changed using the first robot arm 11 and second robot arm 12 of the drive section 1, as shown in FIG. 5 to FIG. 8. However, these examples are only illustrative, and the present disclosure is not limited to these examples.

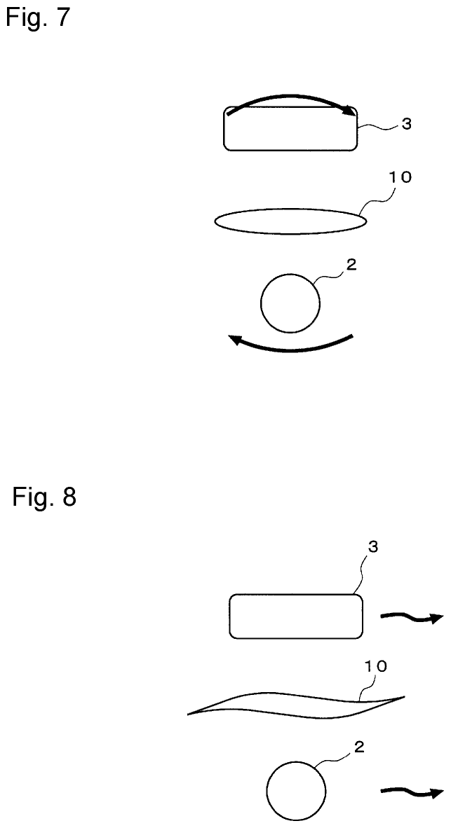

With the example of FIG. 5, the radiation source section 2 and the detection section 3 are moved in parallel in the same direction. With the example of FIG. 6, the radiation source section 2 is rotated, and the detection section 3 is revolved in accordance with the angle of rotation of the radiation source section 2, with the radiation source section 2 as a center. With the example of FIG. 7, the radiation source section 2 and the detection section 3 are rotated in the same direction with the subject 10 as a center. With the example of FIG. 8, the radiation source section 2 and the detection section 3 are moved synchronously so as to meander, in accordance with the curved shape of the subject 10. Here, the radiation source section 2 and the detection section 3 satisfy the previously described positional relationship (specifically, the establishing conditions) during imaging.

In order to perform a measurement of a radiographic phase image in the same manner as in patent publication 2, with this practical example a Fourier transform method is used in advance, as has already been pointed out. After that, it is possible to take a radiographic phase image by relatively moving the subject 10, and the radiation source section 2 or the detection section 3. This procedure is basically the same as that in patent publication 2, and so more detailed description is omitted.

According to this embodiment, it is possible to appropriately set a positional relationship between the radiation source section 2 and the detection section 3 in accordance with the conditions of the subject 10. As a result, in a case where the subject 10 is large, for example, it is possible to perform rapid imaging by moving the radiation source section 2 and the detection section 3 to arbitrary positions, instead of moving the subject 10. Also, in this way there is the advantage of it being possible to simplify a movement mechanism for moving the subject 10. There is a further advantage that it is possible to image a large subject 10 without using a large grating.

### MODIFIED EXAMPLE 1

With the previously described first embodiment, the processing in the same manner as in patent publication 2 was performed adopting a Fourier transform method. By installing the G1 grating 22 in the radiation source 21 by way of a micro motion mechanism such as a piezo stage, it is possible to also implement a fringe scanning method by moving the G1 grating 22 by a specified step at a time, like the procedure in patent publication 2. While there is the disadvantage that weight also increases with increasing structural elements of the radiation source section 2, an advantage of ensuring higher spatial resolution than with a Fourier transform method can be expected.

### Second Embodiment

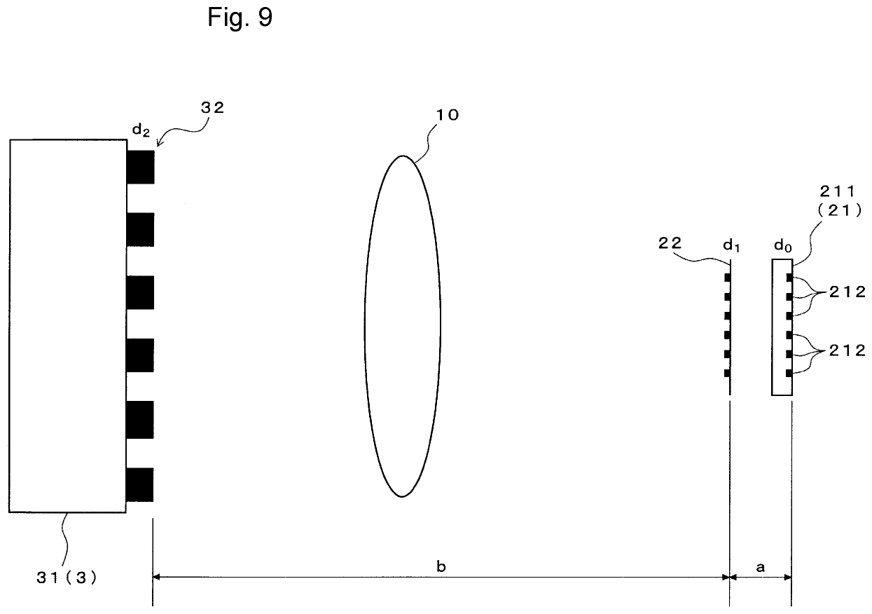

Next, an imaging device of a second embodiment of the present disclosure will be described mainly with reference to FIG. 9. In the description of this second embodiment, duplicated description will be avoided by using the same reference numerals for elements that are basically common to the previously-described first embodiment.

In the previously-described first embodiment, a Lau interferometer configuration with the G2 grating omitted was used. Conversely, in the second embodiment, the detection section 3 is provided with a G2 grating 32 having a pitch of d₂. Accordingly, the image detector 31 of this embodiment is configured to obtain an image of radiation that has passed through the G1 grating 22, the subject 10, and the G2 grating 32. The image detector 31 and G2 grating 32 of this second embodiment are integrated inside the detection section 3.

Also, with the second embodiment, a positional relationship that satisfies the following conditions (equations (1), (2), (4), and (5)) is achieved. Specifically, the pixel size of the image detector 31 becomes larger to a certain extent.

$$\begin{matrix}Equation 1 & \\ 1 - \frac{{d}_{1}}{{d}_{0}} = \frac{a}{a + b} & ( 1 ) \\ Equation 2 & \\ \frac{1}{a} + \frac{1}{b} = \frac{λ}{{pd}_{1}^{2}} & ( 2 ) \\ Equation 4 & \\ 2 D > {d}_{2} = \frac{{d}_{0} {d}_{1}}{{d}_{0} - {d}_{1}} & ( 4 ) \\ Equation 5 & \\ {d}_{2} = \frac{a + b}{a} {d}_{1} & ( 5 )\end{matrix}$$

That is, with this second embodiment, the conditions of equation (4) and equation (5) are satisfied, instead of the conditions of equation (3) mentioned earlier with the first embodiment. However, b here is a distance from the G1 grating 22 to the G2 grating 32 (refer to FIG. 9). Also, the G2 grating 32 and the image detector 31 may be separated.

Since an absorption grating is used here as the G2 grating 32, it is necessary to make the grating thicker. With this second embodiment, d₂>>d₀, d₁, and so there is the advantage that it is possible to make the fabrication of a thick G2 grating 32 easier.

With this practical example, when performing the processing in the same manner as in patent publication 2, a fringe scanning method to translate the detection section 3 relative to the radiation source section 2 is implemented. The translation is performed in the direction of the period the G2 grating 32, maintaining a distance between the radiation source section 2 and the detection section 3. A translation amount required to implement a fringe scanning method is equivalent to the period of the G2 grating 32, and is smaller than the pixel size of the image detector 31 (equation 4). Accordingly, this translation does not pose any particular problem.

In a case where a micro motion mechanism that is the same as that of the previously described modified example 1 is mounted, a fringe scanning method may be implemented using translation of the G1 grating 22. It should be noted that with this practical example, since it is under conditions where a self-image of the G1 grating 22 cannot be resolved, in the case of applying a Fourier transform method that was described in the first embodiment a fine rotation moiré image is generated by inclining the detection section 3 with respect to the radiation source section 2 relatively.

Other configurations and advantages of the second embodiment are basically the same as those of the previously-described first embodiment, and so more detailed description has been omitted.

### Third Embodiment

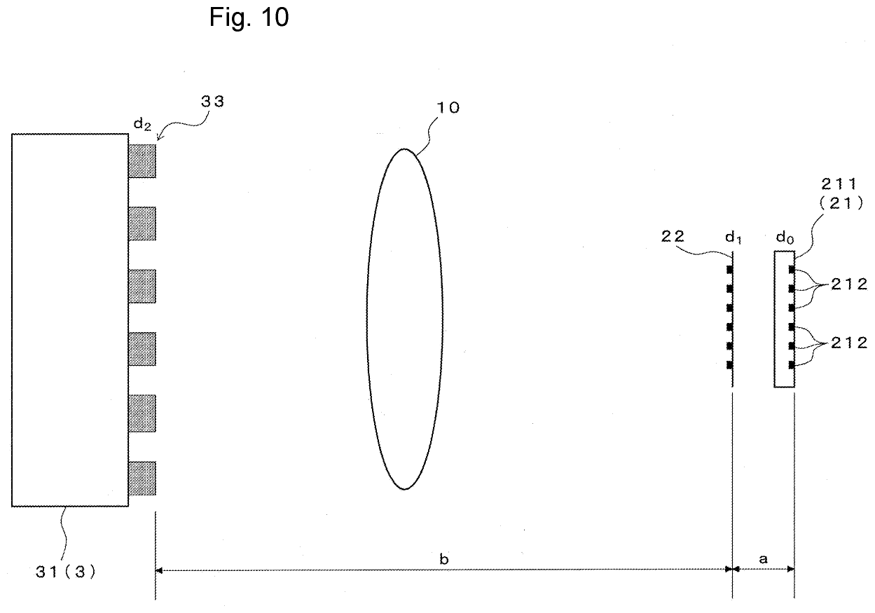

Next, an imaging device of a third embodiment of the present disclosure will be described mainly with reference to FIG. 10. In the description of this third embodiment, duplicated description will be avoided by using the same reference numerals for elements that are basically common to the previously-described second embodiment.

In the previously-described second embodiment, the detection section 3 was provided with the G2 grating 32. Conversely, with this third embodiment, instead of the G2 grating 32, the detection section 3 is provided with a structured scintillator 33 having a pitch of d₂. The structured scintillator 33 is configured having scintillators arranged periodically and discretely, such that only radiation (for example, X-rays) that has been made incident on a scintillator generates light that is capable of being detected by the image detector 31. Also, a film (for example, a metallic film, not illustrated) is formed on a side surface of the structured scintillator for preventing a problem where image contrast is lowered as a result of light that has been generated by input of radiation reaching not only onto pixels directly below the scintillators, but also pixels at the periphery of the scintillators. Further, b here is distance from the G1 grating 22 to the structured scintillator 33.

The image detector 31 of the third embodiment is configured so as to acquire an image of radiation that has passed through the G1 grating 22 and the subject 10, and has been made incident on the structured scintillator 33. Using this configuration, there is the advantage that it is possible to omit installation of the G2 grating with this embodiment.

A method at the time of performing the processing in the same manner as in patent publication 2 is the same as that described for the second embodiment.

Other configurations and advantages of the third embodiment are basically the same as those of the previously described second embodiment, and so more detailed description has been omitted.

### MODIFIED EXAMPLE 2

With the above described second and third embodiments, it is possible to have a configuration whereby the G2 grating 32 or the structured scintillator 33 is microscopically moved a specified step at a time with respect to the image detector 31 (that is, with respect to the radiation) by a micro motion mechanism (not shown). In this case also, it is possible to implement a fringe scanning method utilizing the procedure that is assumed in patent publication 2. Generally, a period of the G2 grating 32 or structured scintillator 33 can be set substantially larger than the period of the G1 grating 22. As a result, this type of structure is much more beneficial in terms of precision and stability of the micro motion mechanism than providing the micro motion mechanism at the radiation source section 2 side.

### MODIFIED EXAMPLE 3

With each of the previously-described embodiments, the first arm and the second arm are respectively constituted by robot arms. However, it is also possible to integrate the first arm and the second arm and to form a substantially C-shape overall. Specifically, it is possible to use a so-called C-arm, with one end made the first arm and the other end section made the second arm.

It should be noted that descriptions for the previously-described embodiments and practical example are merely simple examples, and do not show the essential structure of the present disclosure. The structure of each part is not limited to the above description as long as it falls within the scope of the present disclosure.

For example, with the previously-described embodiments, an X-ray source has been used as the radiation source section, but is also possible to use another radiation source that has permeability with respect to a sample, for example, a neutron source. Obviously, in this case, the detection section is capable of detecting the radiation source that is used.

Also, for example, the image generating section and structural elements thereof can exist as a functional block, and may not necessarily exist as independent hardware. Also, as a method of implementation, it is possible to use hardware or to use computer software. Further, a single functional element of the present disclosure may be realized as a set of a plurality of functional elements, and a plurality of functional elements of the present disclosure may be implemented by a single functional element.

Also, functional elements may be located at positions that are physically separated from one another. In this case, associated functional elements may be connected by means of a network. Functions may be realized by means of grid computing or cloud computing, and alternatively functional elements may also be constituted by means of grid computing or cloud computing.

### DESCRIPTION OF THE REFERENCE NUMERALS

1 drive section

11 first robot arm (first arm)

12 second robot arm (second arm)

2 radiation source section

21 radiation source

211 substrate

212 target members

213 electron source

214 electron beam

22 G1 grating

23 vacuum chamber

3 detection section

31 image detector

32 G2 grating

33 structured scintillator

4 conveying section

10 subject

100 radiation (X-rays)

The various embodiments described above can be combined to provide further embodiments. All of the references and publications referred to in this specification and/or listed in the Application Data Sheet are incorporated herein by reference, in their entirety. Aspects of the embodiments can be modified, if necessary to employ concepts of the various references and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A radiographic phase imaging device, comprising:
a drive section;
a radiation source section; and
a detection section, wherein:
the drive section comprises a first arm and a second arm;
the first arm and the second arm are arranged in a state having a space formed between them in which it is possible to arrange a subject;
the radiation source section is attached to the first arm;
the radiation source section comprises a radiation source that generates radiation, and a G1 grating that allows the radiation to pass through;
the G1 grating is a phase type grating to change phase of the radiation passing through the G1 grating,
the detection section is attached to the second arm;
the detection section is configured to acquire images of the radiation that has passed through the G1 grating and the subject; and
the first arm and the second arm are configured such that the radiation source section and the detection section can be moved within a three dimensional space.

2. The radiographic phase imaging device of claim 1, wherein a structured radiation source having target members arranged periodically is used as the radiation source.

3. The radiographic phase imaging device of claim 2, wherein the structured radiation source and the G1 grating are integrated within the radiation source section.

4. The radiographic phase imaging device of claim 1, wherein:
the detection section comprises an image detector and a G2 grating; and
the image detector is configured to acquire an image of the radiation that has passed through the G1 grating, the subject, and the G2 grating,

5. The radiographic phase imaging device of claim 4, wherein the image detector and the G2 grating are integrated within the detection section.

6. The radiographic phase imaging device of claim 1, wherein:
the detection section comprises an image detector and a structured scintillator; and
the image detector is configured to acquire an image of the radiation that has passed through the G1 grating and the subject, and has been made incident on the structured scintillator.

7. The radiographic phase imaging device of claim 1, wherein the first arm and the second arm are configured to be able to allow movement of one or both of the radiation source section and the detection section along a specified movement trajectory within a three dimensional space, while maintaining a relative positional relationship between the radiation source section and the detection section.

8. The radiographic phase imaging of claim 7, wherein the radiation source section and the detection section are configured to be able to execute imaging while moving one or both of the radiation source section and the detection section along the movement trajectory.

9. The radiographic phase imaging device of claim 1, wherein the first arm and the second arm are respectively constituted using robot arms.

10. The radiographic phase imaging device of claim 1, wherein the first arm and the second arm are integrated, and are formed into a substantially C-shape overall.

11. The radiographic phase imaging device of claim 1, wherein the radiation source section comprises a window formed as a substrate for extracting radiation, and wherein the G1 grating is formed on the window.

12. The radiographic phase imaging device of claim 2, wherein:
the detection section comprises an image detector; and
the imaging device satisfies the following equations (1), (2), and (3):
$$\begin{matrix}Equation 1 & \\ 1 - \frac{{d}_{1}}{{d}_{0}} = \frac{a}{a + b} & ( 1 ) \\ Equation 2 & \\ \frac{1}{a} + \frac{1}{b} = \frac{λ}{{pd}_{1}^{2}} & ( 2 ) \\ Equation 3 & \\ 2 D < \frac{{d}_{0} {d}_{1}}{{d}_{0} - {d}_{1}} & ( 3 )\end{matrix}$$
in which
d₀: pitch of target members;
d: pitch of G1 grating;
a: distance between G1 grating and target members;
b: distance between G1 grating and image detector;
λ: wavelength of radiation;
D: pixel size of image detector, in the direction of grating period of G1 grating; and
p: Talbot order.

13. The radiographic phase imaging device of claim 2, wherein:
the detection section comprises an image detector and a G2 grating;
the image detector is configured to acquire an image of the radiation that has passed through the G1 grating, the subject, and the G2 grating; and
the imaging device satisfies the following equations (1), (2), (4) and (5):
$$\begin{matrix}Equation 1 & \\ 1 - \frac{{d}_{1}}{{d}_{0}} = \frac{a}{a + b} & ( 1 ) \\ Equation 2 & \\ \frac{1}{a} + \frac{1}{b} = \frac{λ}{{pd}_{1}^{2}} & ( 2 ) \\ Equation 4 & \\ 2 D > {d}_{2} = \frac{{d}_{0} {d}_{1}}{{d}_{0} - {d}_{1}} & ( 4 ) \\ Equation 5 & \\ {d}_{2} = \frac{a + b}{a} {d}_{1} & ( 5 )\end{matrix}$$
in which
d₀: pitch of structured radiation source;
d₁: pitch of G1 grating;
d₂: pitch of G2 grating;
a: distance between G1 grating and target members;
b: distance between G1 grating and G2 grating;
λ: wavelength of radiation;
D: pixel size of image detector, in the direction of grating period of G1 grating; and
p: Talbot order.
